(19) United States
(12) Patent Application Publication
(10) Pub. No.: US 2017/0001736 A1
(43) Pub. Date: Jan. 5, 2017

(54) METHOD FOR DETECTING TOPOGRAPHICAL FEATURES OF A SURFACE AND DEVICE FOR SUCH PURPOSE

(71) Applicants: Florian Kolb, Jena (DE); Christoph Heilmann, Jena (DE); Bernd Linhart, Rothenstein (DE)

(72) Inventors: Florian Kolb, Jena (DE); Christoph Heilmann, Jena (DE); Bernd Linhart, Rothenstein (DE)

(21) Appl. No.: 15/201,293

(22) Filed: Jul. 1, 2016

(30) Foreign Application Priority Data
Jul. 2, 2015 (DE) DE102015110649.3

(51) Int. Cl. B64G 1/66; G01S 7/484; G01S 17/89

(52) U.S. Cl. CPC B64G 1/66; G01S 17/89; G01S 7/484

(57) ABSTRACT

A method for detecting topographical features of a surface, in particular, of extraterrestrial surfaces, light pulses having a predefined output pulse shape being emitted to the surface with the aid of a laser light source and light pulses (2) reflected by the surface having an input pulse shape of the light intensity modified by the surface being detected over the transit time with the aid of a receiver (3), and this at least one topographical feature of the surface being ascertained based on an analysis of the modified input pulse shapes, is provided.

This claims the benefit of German Patent Application DE10 2015 110 649.3, filed Jul. 2, 2015 and hereby incorporated by reference herein.

The present invention relates to a method and a device for detecting topographical features of a surface, in particular, extraterrestrial surfaces.

### BACKGROUND

Generic methods and devices in the form of LIDAR sensors (Light detection and ranging) for detecting topographical features of a surface are known, for example, from the publications AT 414 175 B, AT 505 037 B1 and DE 10 2006 049 935 A1 for high resolution generation of 3D point clouds in terrestrial use, for example, from cartography, geography, archaeology, and surveying. The LIDAR sensors in these uses function according to the principle of transit time measurement—a short light pulse is emitted by the sensor, reflected by the target object and the transit time of the light pulse back to the sensor is measured. The distance to the target object is then determined from the transit time via the light speed. To increase accuracy, the analysis of the returning pulse shape is referred to in part. In such case, the returning pulse is digitized at a high resolution in order to determine pulse parameters, such as maximum or pulse width using data processing methods, to detect multiple reflections, for example, by trees or in order to eliminate distortions and, therefore, to obtain exact and undistorted transit times of the light pulses.

In present considerations on the detection of topographical features of an extraterrestrial surface, the use of LIDAR sensors is being discussed for hazard detection (hazard detection and avoidance) in extraterrestrial landing missions, for example, on the moon or for docking two spacecraft to one another. For example, a lander is equipped with one or multiple LIDAR sensors, which detect the potential landing area as a 3D point cloud during the descent to the surface. On the basis of the 3D point cloud, it is possible to calculate relevant hazards for the lander, such as boulders, craters or excessive ground sloping using image processing methods. In the process, a 3D point cloud is developed based on a plurality of received light pulses, to which a local component and a precisely ascertained transit time are assigned. To determine and localize the hazards using image processing methods, high demands are placed on the density of the point cloud and, thus, on the efficiency of the LIDAR sensor and a connecting data processing system, for example, a computer having corresponding memory units, since the resolution must be high enough in order to correctly detect relevant hazards. This means, in particular, that the LIDAR sensor must scan the surface at a very high resolution in order to resolve relevant hazards well enough that the subsequent data processing is able to recognize and evaluate the hazards as such. Consequently, the data processing system must process a large quantity of data in a short period of time. Since the electronics for space travel applications lack the capacity of commercial electronics, this may result in complex systems having high electrical power consumption.

### SUMMARY OF THE INVENTION

It is an object of the present invention to provide a method and a device, which enables the detection and categorization of topographical features of a surface with the aid of a less high-resolving device, and which makes a simpler design of a downstream data processing system possible. In addition, a partial object of the present invention is to construct the device more simply. A partial object of the present invention is also to reduce the electrical power consumption. A partial object of the present invention is also to reduce the costs, the development risk and/or manufacturing risk.

The method described is used to detect topographical features of a surface. The method is used, in particular, to detect extraterrestrial surfaces, for example, surfaces in the landing areas of spacecraft, such as landers and the like, in order to assess a selected landing site as suitable or unsuitable. In this method, it is provided to emit light pulses of a laser light source, such as lasers having a predefined output pulse shape, to the surface with the aid of a LIDAR sensor or the like. The light pulses emitted and reflected by the surface are modified with respect to their profile shape of the light intensity over the transit time as a function of the topographical features of the surface. The reflected light pulses with the input pulse shape modified by the surface are detected with the aid of a receiver. From this, it is possible to ascertain at least one topographical feature of the surface based on a comparison of the input pulse shapes with reference pulse shapes. For example, based on the comparison of the reference pulse shape and the input pulse shape, it is possible to deduce a hazard existing on the surface. It has been shown that, in contrast to a hazard detection with the aid of a 3D point cloud, in which a hazard can only be detected with reference to many light pulses based on the comparison of the transit times or the maximum of a distribution of the light intensity over the transit time of the light pulses of adjacent surface segments, it is possible to ascertain a topographical feature of the surface, for example, a favorable or unfavorable landing site for a landing of a spacecraft, by analyzing the input pulse shape of a single light pulse. This means that a method for analyzing the input pulse shapes of reflected light pulses provides a significantly higher information density than the evaluation of the transit times of light pulses according to the prior art. Based on this, it is possible given the same weight and electrical output to obtain a higher information density or—particularly advantageous when applied to space travel—given the same resolution, devices having lower weight, lower electrical output, lower data processing volume, lower computing capacity and the like. The method described is suitable, in particular, for applications for space travel, since there are no disruptive reflections otherwise modifying the pulse shape to be expected between the device and the surface to be detected. With the aid of the method described, light and robust LIDAR systems of simple design compared to known LIDAR systems may also be provided for the preparation of a landing of a spacecraft on unknown surfaces. In such case, it is possible with the aid of the method described to dispense with a precise imaging of the surface with the aid of high-resolution and data-intensive LIDAR systems by detecting the hazards relevant for a landing with the aid of lower resolution.

In one preferred specific embodiment, the output pulse shapes of light pulses of the laser light source are used as reference pulse shapes. In this way, a light pulse may be fed directly to the receiver with the aid of a beam splitter, so that in the simplest case, the behavior significant for the surface may be ascertained by forming the difference between the input pulse shape and the output pulse shape of a light pulse, while taking the otherwise secondary transit time of the light pulse between the laser light source and the surface and back into account. The significant pulse shapes or input pulse shapes themselves ascertained in this way may be compared, for example, with predefined pulse shapes of a shape inventory of a library of a data processing system or the like, allowing conclusions to be drawn about the shape of the surface. Alternatively or in addition, the topographical features may be mapped and, if necessary, stored, based on individual or a sum total of multiple input pulse shapes of multiple light pulses incorporated, for example, in a grid across the surface. For example, the topography of a predefined section of the surface may be mapped with the aid of multiple light pulses analyzed with respect to their input pulse shape. A hazard map of an extraterrestrial landing target is preferably ascertained from the analysis of the pulse shapes as input shapes of the light pulses emitted by the laser light source.

The input pulse shapes of the light pulses are preferably detected in analog with the aid of light detectors with reference to the light intensity over their transit time from the laser light source to the surface and back to the receiver. The emitted and received light pulses are then digitized and their input pulse shapes are digitally analyzed, i.e., compared with a reference pulse shape and/or with other input pulse shapes at the same sites or with light pulses reflected at adjacent sites, from which topographical features of the studied surface are ascertained.

The input pulse shapes may be analyzed and evaluated in real time given the appropriate computing capacity of the data processing system. It has proven advantageous, however, to store the emitted and received light pulses in a memory in real time and to subsequently analyze and evaluate their pulse shapes. In such case, the use of a transient recorder for recording the light pulses and their input pulse shapes has proven particularly advantageous. In this way, the computing capacity may be designed lower and, therefore, more robust for a predefined performance.

The device provided is used to carry out the method described. The device is used, in particular, for carrying out the method in a spacecraft for detecting a suitable landing site on an extraterrestrial surface. The device contains a laser light source, a control unit, for example, a computer, controlling the laser light source for generating light pulses having a predefined output pulse shape, an on-board computer of the spacecraft or the like, and imaging optics downstream from the laser light source. The imaging optics may be scan-operated by the control unit, i.e., guided on a linear path or flat grid with respect to the surface. The device further includes a receiver for the light pulses emitted by the laser light source and reflected by the surface, having a detector and a converter converting the reflected light pulses into electrical signals. To process the detected light pulses with the corresponding input pulse shapes converted to electrical signals, a data processing system is provided, which may be stored as a program, for example, in the control unit and may access volatile or non-volatile memories, may retrieve stored data and may save data in the control unit. The data processing system also carries out the calculation steps for analyzing the pulse shapes of the light pulses and, if necessary, for mapping the topographical features of surfaces.

The device may be designed as a LIDAR sensor, for example, the data processing system being integrated into the LIDAR sensor. In this way, the device may be designed as a modular unit, which communicates the topographically analyzed surface, for example, a suitable landing site, with the aid of an interface. The LIDAR sensor may contain a detector, which detects a predefined section of the surface with the aid of a sequentially scanning mirror system. Alternatively, the detector may be designed as a detector array detecting a predefined section of the surface in its entirety.

The converter of the receiver may be designed as an analog-digital converter, which digitizes the input pulse shapes and, if necessary, the output pulse shapes detected as reference pulse shapes, i.e., detects a light intensity in a majority of transit time windows within the input pulse shapes. The converter may be alternatively designed as a transient recorder.

In other words, the method described is based on the effect that geometric features of the surface impact the shape of a light pulse emitted by a laser light source, reflected at the surface and captured by the receiver. As a result, the surface features may be inferred on the basis of specific properties of the pulse shape and, thus, the surface element may be evaluated as a hazard with respect to that property. Using a LIDAR sensor, a surface region in its entirety may be detected, for example, sequentially by a scanning mirror system and a sequence of light pulses, or in its entirety with the aid of a detector array. In this case, the method described is carried out individually for each detected light pulse and may be compiled subsequently in a data processing system to form a hazard map of the entire surface region. The incoming light pulse is converted in a receiver into an electrical pulse, which is digitized with the aid of an electronic circuit. In this case, either a continuously operating analog-digital converter with high temporal resolution may be used or a principle corresponding to the function of a transient recorder may be applied, in order to quickly buffer the pulse values in analog form and to subsequently digitize them at a lower speed. The digitized pulse shape may then be stored in a buffer for further processing. In a subsequent step, the stored digital pulse shape is analyzed. The following criteria may be applied in order to achieve the goal of mapping a hazard:
Determination of the pulse length for evaluating the inclination angle of the surface,
Determination of multiple reflections or irregularly shaped pulses for evaluating the surface roughness.

### BRIEF DESCRIPTION OF THE DRAWINGS

The present invention is explained in greater detail with reference to the exemplary embodiment depicted in FIGS. 1 and 2.

FIG. 1 shows a sequence for analyzing profile shapes of light pulses reflected by a surface and

FIG. 2 shows three exemplary embodiments of pulse shapes of a light pulse modified by various surfaces.

### DETAILED DESCRIPTION

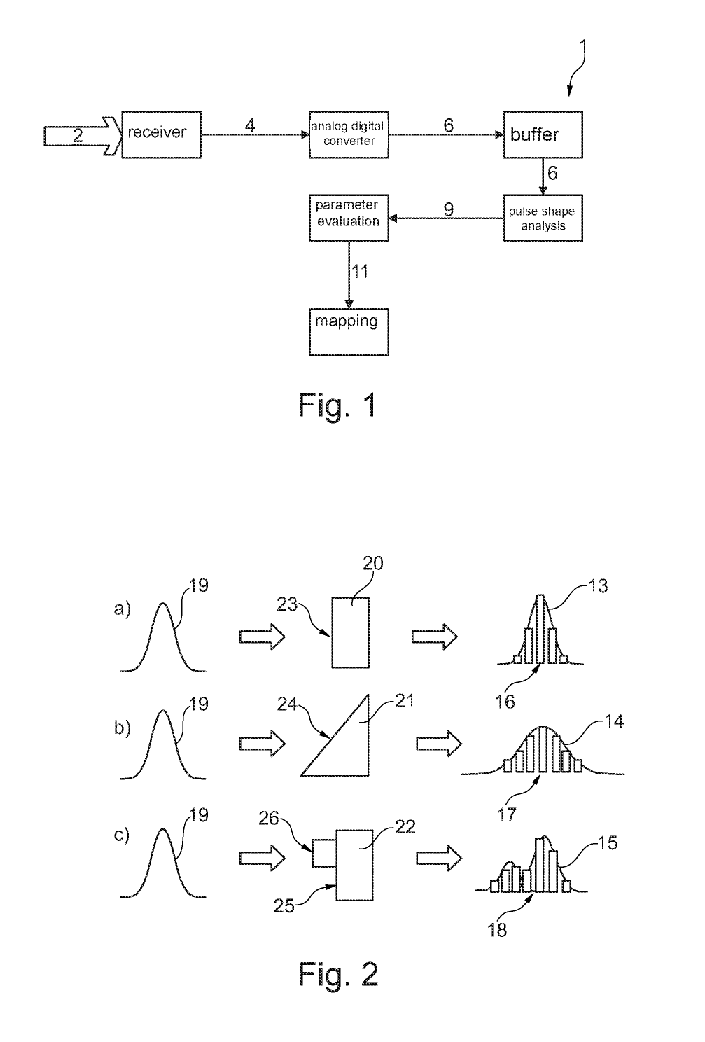

FIG. 1 shows sequence 1 of the method described for a spacecraft for preparation of a landing on a surface of unknown topographical quality. The single run-through of the method analyzes a profile shape of a light pulse which has been reflected by the surface. The light pulse is generated in accordance with the prior art in the form of an output pulse shape generated, for example, with the aid of a laser light source and emitted at a predefined location on the surface. Light pulse 2 reflected by the surface having an input pulse shape of an optical intensity over the transit time, is detected by receiver 3, for example, an optical receiving device, such as a LIDAR sensor, and converted into an analog electrical pulse 4. Analog electrical pulse 4 is converted in analog-digital converter 5 to a digitized pulse shape 6 and stored in virtual real time in buffer 7. After a predefined time interval, digitized pulse shape 6 is retrieved from buffer 7 and subjected to a pulse shape analysis 8, from which pulse parameters 9 are derived as a function of topographical features. The correlation between digitized pulse shape 6 and pulse parameters 9 is made, for example, by empirically assigning digitized pulse shapes 6 to corresponding topographical features of the surface. Pulse shape analysis 8 in this case may be structured from simple geometrical elements, which may be used separately or linked combinatorially to one another. Adaptive systems of a pulse shape analysis 8 such as, for example, neuro-fuzzy systems, may also be provided. Pulse parameter 9 assigned to a digital pulse shape 6 is evaluated in parameter evaluation 10 with respect to its relevance as a hazard. Parameter evaluation 10 then outputs a hazard evaluation 11, for example, as a flag or a graduated variable, which is used in mapping 12 as a component of a map for a predefined location. A plurality of light pulses 2 reflected at different locations and subject to sequence 1 results finally in a map with hazard evaluation compiled point by point.

Sub-diagrams a), b), c) in FIG. 2 show different analog input pulse shapes 13, 14, 15 and resultant digitized input pulse shapes 16, 17, 18. The different analog input pulse shapes 13, 14, 15 are the result of the light pulses having output pulse shape 19 emitted by a laser light source, depicted identically in each case here. Reflection at different bodies 20, 21, 22 with reflection surfaces 23, 24, 25, 26 corresponding to different surfaces results in each case in different and specific analog input pulse shapes 13, 14, 15, which, subsequent to digitization, correspond to digitized input shapes 16, 17, 18, which are mathematically easier to analyze.

In particular, a planar reflection surface 23 is present in sub-diagram a). Here, output pulse shape 19 largely coincides with input pulse shape 13. Reflection surface 23, which is struck by the corresponding light pulse having output shape 19 and reflected, may therefore be assumed to be planar and perpendicular to the propagation direction of the light pulse.

In sub-diagram b), input pulse shape 14 is widened as compared to output pulse shape 19. The widened, i.e., input-delayed input pulse shape 14 is generated as a result of the light pulse being reflected by each sub-region of reflection surface 24 at a different distance and, therefore, with a different transit time. A surface topographically inclined compared to the propagation direction of the light pulse may therefore be deduced.

In sub-diagram c), input pulse shape 15 appears with two maxima, which may be attributed to two single reflections. In the case of such input pulse shapes 15, a surface having two reflection surfaces 25, 26 offset in the propagation direction may be deduced.

It is understood that the exemplary embodiments depicted are model-like in character for representing the method described and that in real settings the input pulse shapes are more complex.

### LIST OF REFERENCE NUMERALS

1 sequence
2 light pulse
3 receiver
4 electrical pulse
5 analog-digital converter
6 digitized pulse shape
7 buffer
8 pulse shape analysis
9 pulse parameter
10 pulse evaluation
11 hazard evaluation
12 mapping
13 analog input pulse shape
14 analog input pulse shape
15 analog input pulse shape
16 digital input pulse shape
17 digital input pulse shape
18 digital input pulse shape
19 output pulse shape
20 body
21 body
22 body
23 reflection surface
24 reflection surface
25 reflection surface
26 reflection surface

What is claimed is:

1. A method for detecting topographical features of a surface, the method comprising:
emitting light pulses having a predefined output pulse shape to the surface with the aid of a laser light source,
detecting with the aid of a receiver light pulses reflected by the surface having an input pulse shape of a light intensity over a transit time modified by the surface; and
ascertaining at least one topographical feature of the surface based on an analysis of the modified input pulse shapes.

2. The method as recited in claim 1 wherein a hazard present on the surface is deduced by a comparison of an input pulse shape with a reference pulse shape.

3. The method as recited in claim 1 wherein an output pulse shape of an emitted light pulse is used as a reference pulse shape.

4. The method as recited in claim 1 wherein the received light pulses are digitized and digitized input pulse shapes are digitally analyzed.

5. The method as recited in claim 1 wherein the emitted and received light pulses are digitally stored in a buffer in real time and a digital pulse shape of the emitted and received light pulses is subsequently analyzed.

6. The method as recited in claim 1 wherein a topography of a predefined section of the surface is mapped with the aid of multiple light pulses analyzed with respect to the input pulse shapes.

7. The method as recited in claim 6 wherein a hazard map of an extraterrestrial landing target is ascertained from the analysis of digital pulse shapes.

8. The method as recited in claim 1 wherein the surface is an extraterrestrial surface.

9. A device for carrying out the method as recited in claim 1 comprising:
a laser light source;
a control unit of the laser light source for generating light pulses having a predefined output pulse shape;
imaging optics downstream of the laser light source;
a receiver including a detector converting the reflected light pulses into electrical pulses;
a converter converting the electrical pulses into digital pulse shapes; and
a data processor analyzing and evaluating the digital pulse shapes.

10. The device as recited in claim 9 wherein the device is designed as a LIDAR sensor including the detector, the detector detecting a predefined section of the surface with the aid of a sequentially scanning mirror system.

11. The device as recited in claim 9 wherein detector is designed as a detector array detecting a predefined section of the surface in its entirety.

12. The device as recited in claim 9 wherein the converter is designed as an analog-digital converter.

13. The device as recited in claim 9 wherein the converter is designed as a transient recorder.

14. A spacecraft comprising the device as recited in claim 9.
